(19) United States
(12) Patent Application Publication
(10) Pub. No.: US 2006/0203933 A1
(43) Pub. Date: Sep. 14, 2006

(54) Data processing method, network element, transmitter, component and computer program product

(75) Inventor: Ling Yu, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/330,186

(22) Filed: Jan. 12, 2006

(30) Foreign Application Priority Data
Mar. 11, 2005 (FI) 20050264

(51) Int. Cl. H04L 27/20

(52) U.S. Cl. 375/295

(57) ABSTRACT

A transmitter includes means for searching for and storing a maximum limit for a combined coding rate. The transmitter also includes means for selecting a first coding rate for a first transmission. The transmitter also includes means for selecting a new coding rate for a following transmission on the basis of the maximum limit of the combined coding rate and the first coding rate if a retransmission is required.

### FIELD

The invention relates to a data processing method in a communication system, a network element, a transmitter, a component and a computer program product.

### BACKGROUND

In modern communication systems, packet-switched traffic is becoming more and more important. Delivery of digital data over mobile networks as well as IP-based (IP=lnternet Protocol) person-to-person communication combining different media and services into the same session increases the use of packet-switched services.

High Speed Downlink Packet Access, HSDPA, is able to provide high data rate transmission to support multimedia services. HSDPA brings high-speed data delivery to 3G terminals.

In the Wideband Code Division Multiple Access (WCDMA) concept, HSDPA implementations usually include Adaptive Modulation and Coding (AMC), Multiple-input Multiple-Output (MIMO), Hybrid Automatic Repeat Request (HARQ), fast cell search, and advanced receiver design.

Automatic Repeat Request (ARQ) or Hybrid Automatic Repeat Request (HARQ) perform an error-control system in that a receiver generates a request for retransmission, if an error in transmission is detected. When a receiver detects an error in a packet, it automatically requests a transmitter to retransmit the packet.

When studying HSDPA, performance degradation in turbo decoding has been detected. It has been found that the performance of turbo decoders may degrade as much as 3 dB with a certain coding rate.

### BRIEF DESCRIPTION OF THE INVENTION

According to an aspect of the invention, there is provided a data processing method in a communication system, the method comprising: searching for and storing a maximum limit for a combined coding rate; selecting a first coding rate for a first transmission; selecting a new coding rate for a following transmission on the basis of the maximum limit of the combined coding rate and the first coding rate if a retransmission is required.

According to another aspect of the invention, there is provided a transmitter, comprising: means for searching for and storing a maximum limit for a combined coding rate; means for selecting a first coding rate for a first transmission; means for selecting a new coding rate for a following transmission on the basis of the maximum limit of the combined coding rate and the first coding rate if a retransmission is required.

According to another aspect of the invention, there is provided a component of a transmitter, the component comprising: means for searching for and storing a maximum limit for a combined coding rate; means for selecting a first coding rate for a first transmission; means for selecting a new coding rate for a following transmission on the basis of the maximum limit of the combined coding rate and the first coding rate if a retransmission is required.

According to another aspect of the invention, there is provided a network element comprising: means for searching for and storing a maximum limit for a combined coding rate; means for selecting a first coding rate for a first transmission; means for selecting a new coding rate for a following transmission on the basis of the maximum limit of the combined coding rate and the first coding rate if a retransmission is required.

According to another aspect of the invention, there is provided a computer program product encoding a computer program of instructions for executing a computer process for data processing, the computer process comprising: searching for and storing a maximum limit for a combined coding rate; selecting a first coding rate for a first transmission; selecting a new coding rate for a following transmission on the basis of the maximum limit of the combined coding rate and the first coding rate if a retransmission is required.

According to another aspect of the invention, there is provided a transmitter, configured to: search for and store a maximum limit for a combined coding rate; select a first coding rate for a first transmission; select a new coding rate for a following transmission on the basis of the maximum limit of the combined coding rate and the first coding rate if a retransmission is required.

According to another aspect of the invention, there is provided a component of a transmitter, configured to: search for and store a maximum limit for a combined coding rate; select a first coding rate for a first transmission; select a new coding rate for a following transmission on the basis of the maximum limit of the combined coding rate and the first coding rate if a retransmission is required.

According to another aspect of the invention, there is provided a network element, configured to: search for and store a maximum limit for a combined coding rate; select a first coding rate for a first transmission; select a new coding rate for a following transmission on the basis of the maximum limit of the combined coding rate and the first coding rate if a retransmission is required.

According to another aspect of the invention, there is provided a computer program product encoding a computer program of instructions for executing a computer process for data processing, the computer process configured to: search for and store a maximum limit for a combined coding rate; select a first coding rate for a first transmission; select a new coding rate for a following transmission on the basis of the maximum limit of the combined coding rate and the first coding rate if a retransmission is required.

The invention provides several advantages.

In an embodiment of the invention, the dynamic coding rate selection for retransmissions that takes into account the effects of the combined coding rate is introduced. Thus the performance degradation in turbo decoders can be minimized or even avoided. This improves the block error rate, BLER, of data transmissions and reduces the number of retransmissions.

### LIST OF DRAWINGS

In the following, the invention will be described in greater detail with reference to the embodiments and the accompanying drawings, in which

FIG. 1 shows an example of a communication system,

FIG. 2 is a flow chart,

FIG. 3 illustrates an example of H-ARQ functionality, and

FIG. 4 illustrates a transmitter.

### DESCRIPTION OF EMBODIMENTS

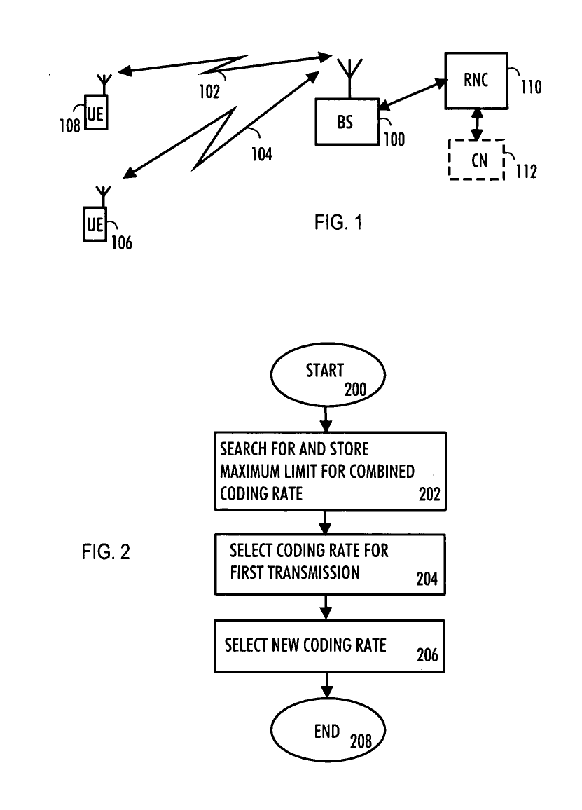

With reference to FIG. 1, we examine an example of a communication system to which embodiments of the invention can be applied. The present invention can be applied to various communication systems. One example of such a communication system is the Universal Mobile Telecommunications System (UMTS) radio access network (UTRAN). It is a radio access network which includes wideband code division multiple access (WCDMA) technology and can also offer real-time circuit and packet switched services. The embodiments are not, however, restricted to the systems given as examples but a person skilled in the art may apply the solution to other communication systems provided with the necessary properties.

It is clear to a person skilled in the art that the method according to the invention can be applied to systems utilizing different modulation methods or air interface standards.

FIG. 1 is a simplified illustration of a part of a digital data transmission system to which the solution according to the invention is applicable. This is a part of a cellular radio system, which comprises a base station (or a node B) 100, which has bidirectional radio links 102 and 104 to user terminals 106 and 108. The user terminals may be fixed, vehicle-mounted or portable. The base station includes transceivers, for instance. From the transceivers of the base station, there is a connection to an antenna unit that establishes the bidirectional radio links to the user terminal. The base station is further connected to a controller 110, such as a radio network controller (RNC), which transmits the connections of the terminals to the other parts of the network. The radio network controller controls in a centralized manner several base stations connected to it. The radio network controller is further connected to a core network 112 (CN). Depending on the system, the counterpart on the CN side can be a mobile services switching centre (MSC), a media gateway (MGW) or a serving GPRS (general packet radio service) support node (SGSN).

The radio system can also communicate with other networks, such as a public switched telephone network or the Internet.

The size of the communication systems can vary according to the data transfer needs and to the required coverage area.

Next, by means of FIG. 2, an embodiment of a data processing method in a communication system is explained in further detail. The embodiment is especially suitable for improving the performance of a turbo decoder when data has to be retransmitted. The embodiment presents the dynamic coding rate selection. The dynamic coding rate selection means that coding rates for possible retransmissions are selected by the aid of evaluating the effects of coding rate combinations in the turbo decoder.

In Universal Mobile Telecommunications System (UMTS) systems based on WCDMA, when High Speed Downlink Packet Access (HSDPA) is in use, a Hybrid-Automatic Repeat Request (H-ARQ) is an important feature to enhance the performance of packet data transmission. H-ARQ controls and initiates packet transmission on layer 1 (physical layer), to reduce retransmission delay.

In WCDMA, HSDPA improves system capacity and increases user data rates in the downlink direction. The improvement is mainly based on adaptive modulation and coding, a fast scheduling function and fast retransmissions with soft combining and incremental redundancy.

In the case of a link error, caused for instance by interference, the user terminal can request retransmission of corrupted data packets.

H-ARQ is typically implemented by using two rate-matching stages and a virtual memory buffer. In principle, the first rate matching stage matches a selected number of input bits to the virtual buffer. The second rate matching stage matches the number of bits after the first rate matching stage to physical channel bits for one Transmission Time Interval (TTI). The H-ARQ rate-matching is usually based on incremental redundancy controlled by Redundancy Version (RV) parameters. For example, Chase Combining (CC) is considered as a particular case of incremental redundancy.

Media Access Control (MAC) entity in UMTS terrestrial radio access network (UTRAN) is responsible for determining a suitable RV for each Protocol Data Unit (PDU). MAC is the lower of the two sub-layers of the Data Link Layer.

The embodiment starts in block 200. In block 202, a maximum limit for a combined coding rate is searched for and stored.

The searching can be carried out in several ways, one example of which is link level simulations, where the signal-to-noise ratio (SNR) performance for different coding rates under a certain block error rate (BLER) is examined.

The results may be stored in a look-up table, for instance.

In block 204, a first coding rate for a first transmission is selected.

The transport block (TB) size, the number of High Speed-Physical Downlink Shared Channel (HS-PDSCH) codes and the modulation scheme are usually known after a transport Format and Resource Combination (TFRC) parameter selection is made. According to the coding chain defined in the 3GPP (3^{rd} Generation Partnership Project) TS 25.211 standard, the number of systematic bits in the output of a Turbo encoder can be expressed as:

$$I = TBsize + 24 + ⌈ \frac{TBsize + 24}{5114} ⌉ \cdot 4 , \qquad ( 1 )$$

wherein

TBsize denotes Transport Block size, and

┌x┐ denotes the operation of rounding up to the nearest integer of x.

After the first rate matching stage, the number of systematic bits is kept the same as before the first rate matching. The number of first (1) parity bits and second (2) parity bits may be as follows:
P1=min(└(N_{IR}−I)/2┘,I)
P2=min(┌(N_{IR}−I)/2┐,I)¹ (2)

wherein

min denotes a minimum,

N_{IR} denotes the maximum number of soft channel bits available in the virtual buffer (typically Incremental Redundancy, IR, buffer). In the HSDPA system, N_{IR} is determined on a higher layer based on the information from a user terminal,

I denotes the number of systematic bits in the output of a Turbo encoder obtained from equation (1),

└x┘ denotes the operation of rounding down to the nearest integer of x, and

┌x┐ denotes the operation of rounding up to the nearest integer of x.

For the first transmission (not a retransmission) of each Transport block (TB) a Redundancy Version (RV) parameter is usually selected. In the first transmission, it is preferable to priorities systematic bits. Therefore, RV=0 may be selected for the first transmission of each TB.

In block 206, if a retransmission is required, a new coding rate for a following transmission is selected on the basis of the maximum limit of a combined coding rate and the first coding rate.

In principle, if one or more retransmissions are required, the parity bits that were punctured in the previous transmissions should be transmitted in the following transmission to maximize the coding gain. Hence, the RV parameter that enables the transmission of most of the earlier punctured parity bits should be selected. This RV parameter is defined as a Full Incremental Redundancy FIR RV parameter. In UMTS, the coding rate selection is based on RV parameter selection.

According to the embodiment, a new RV parameter is not, however, allowed to lead to a performance loss in a turbo decoder, as described above.

The coding rate (or the RV parameter) is typically selected taking into consideration the performance degradation caused by the disadvantageous coding rate combination in the light of the performance loss caused by the coding rate selection (in UMTS usually an RV parameter) that is not optimal in maximising the transmission of punctured parity bits of previous transmissions. That is to say, the coding rate selection is typically based on examining the performance degradation caused by coding rate combinations, taking into consideration the performance loss caused by the decreased number of previously punctured parity bits to be transmitted. Next, an example of the coding rate selection for one or more retransmissions is explained in more detail.

If the punctured parity bits are going to be transmitted, RV should be selected to be 3. In that case, the combined coding rate CR₂ after the retransmission can be calculated:

$$if p 1 - Pt 1 + P 2 - Pt 2 \leq {N}_{data} , then {CR}_{2} = \frac{I}{I + P 1 + P 2} \\ otherwise {CR}_{2} = \frac{I}{2 {N}_{data}} , \qquad ( 3 )$$

wherein

P1 denotes the number of first parity bits in the output of a Turbo encoder

Pt1 denotes the number of first parity bits in the first transmission,

P2 denotes the number of second parity bits in the output of a Turbo encoder,

Pt2 denotes the number of second parity bits in the first transmission,

I denotes the number of systematic bits in the output of a Turbo encoder obtained from equation (1), and
N_{data}=480·S·N_{codes}, (4)

wherein

S=2 for QPSK,

S=4 for 16 QAM, and

N_{codes} denotes the number of HS-PDSCH codes.

The combined coding rate leads to performance degradation of a Turbo decoder if

$$\vert {CR}_{2} - \frac{3.5 N}{3.5 N + 2} \vert < ɛ , \qquad ( 5 )$$

wherein

CR₂ denotes combined coding rate and is obtained from equation (3),

ε is the maximum limit for a combined coding rate obtained in block 202,

|x| denotes absolute value of x, and

$$N = \vert \frac{4 I}{7 \cdot min ( P 1 + P 2 , 2 \cdot {N}_{data} - I )} + 0.5 \vert , \qquad ( 6 )$$

wherein

I denotes the number of systematic bits in the output of a Turbo encoder obtained from equation (1),

min denotes a minimum,

P1 denotes the number of first parity bits in the output of a Turbo encoder,

P2 denotes the number of second parity bits in the output of a Turbo encoder,

|x| denotes absolute value of x, and
N_{data}=480·S·N_{codes}, (4)

wherein

S=2 for quadrature phase shift keying (QPSK),

S=4 for 16-QAM (QAM=quadrature amplitude modulation), and

N_{codes} denotes the number of HS-PDSCH (HS-PDSCH=High Speed Downlink Shared Channel) codes.

If a combined coding rate which maximizes the number of earlier punctured bits in the retransmission causes performance degradation in a turbo decoder, another coding rate for a retransmission will be selected. In UMTS, an RV parameter called Partial Incremental Redundancy (PIR RV) can be selected. If also the selected PIR RV parameter leads to performance degradation, a Chase Combining Incremental Redundancy (CC RV) parameter can be selected.

In the example, if the coding rate selection (or RV parameter selection) leads to performance degradation that is larger than the performance loss caused by the change from an FIR parameter to a PIR parameter (the comparison may be carried out by link level simulations), RV=1 cannot be selected because it will give the same combined coding rate. Therefore, in this example, the selection is RV=2 for the first retransmission. In this case, the combined coding rate CR₂ after the first retransmission (RV=0 for the first transmission and RV=2 for the first retransmission), can be calculated as follows:

$${CR}_{2} = \frac{I}{min ( I + 2 Pt 1 + 2 Pt 2 , {N}_{IR} )} , \qquad ( 7 )$$

wherein

min denotes a minimum,

I denotes the number of systematic bits in the output of a Turbo encoder obtained from equation (1),

Pt1 denotes the number of first parity bits in the first transmission,

Pt2 denotes the number of second parity bits in the first transmission, and

N_{IR} denotes the maximum number of soft channel bits available in the virtual buffer (typically Incremental Redundancy, IR, buffer). In HSDPA system, N_{IR} is determined on a higher layer based on the information from a user terminal.

Equation (5) may be used again to determine whether the combined coding rate (RV=0 for the first transmission and RV=2 for the first retransmission) will lead to performance degradation in a turbo decoder. If performance degradation larger than the performance loss caused by the parameter selection from PIR RV to CC RV will occur, RV=0 for QPSK and RV=4 for 16-QAM will preferably be selected for the first retransmission. In this case, the combined coding rate will be the same as the coding rate in the first transmission.

If further retransmissions are required, the following RV parameter sequences are found usable by simulations:
RV_{QPSK}={0,3,0,3,0,3, . . . }
RV_{QPSK}={0,2,0,2,0,2, . . . } or {0,2,4,0,2,4, . . . } or {0,2,4,6,0,2,4,6, . . . }
RV_{QPSK}={0,0,0,0, . . . }
RV_{16-QAM}={0,3,4,1,0,3,4,1, . . . }
RV_{16-QAM}={0,2,0,2,0,2, . . . }
RV_{16-QAM}={0,4,0,4,0,4, . . . }.

Attention should be paid to the fact that RV parameter sequences for the following retransmissions listed above depend on the RV parameter used in the second (or previous) transmission.

Further in the example, if RV=2 is used for the first retransmission and the modulation scheme is QPSK, the RV parameter for the second retransmission is preferably be selected taking into account the combined coding rate. In this case, RV=4 is selected for the second retransmission and the combined coding rate can be calculated as:

$${CR}_{3} = \frac{I}{min ( I + 3 Pt 1 + 3 Pt 2 , {N}_{IR} )} , \qquad ( 8 )$$

wherein

min denotes a minimum,

I denotes the number of systematic bits in the output of a Turbo encoder obtained from equation (1),

Pt1 denotes the number of first parity bits in the first transmission,

Pt2 denotes the number of second parity bits in the first transmission, and

N_{IR} denotes the maximum number of soft channel bits available in the virtual buffer (typically Incremental Redundancy, IR, buffer). In HSDPA system, N_{IR} is determined on a higher layer on the basis of the information from a user terminal,

If the combined coding rate leads to performance degradation according to equation (5) and the performance degradation is larger than the performance loss caused by the parameter change from FIR to PIR, it is recommendable to select sequence RV_{QPSK}={0,2,0,2,0,2, . . . }. Otherwise, sequence {0,2,4,0,2,4, . . . } or {0,2,4,6,0,2,4,6, . . . } may be selected.

If a third retransmission is needed, the combined coding rate can be calculated as:

$${CR}_{4} = \frac{I}{min ( I + 4 Pt 1 + 4 Pt 2 , {N}_{IR} )} , \qquad ( 9 )$$

wherein

min denotes a minimum,

I denotes the number of systematic bits in the output of a Turbo encoder obtained from equation (1),

Pt1 denotes the number of first parity bits in the first transmission,

Pt2 denotes the number of second parity bits in the first transmission, and

N_{IR} denotes the maximum number of soft channel bits available in the virtual buffer (typically Incremental Redundancy; IR, buffer). In the HSDPA system, N_{IR} is determined on a higher layer on the basis of the information from a user terminal.

If the combined coding rate leads to performance degradation larger than the performance loss caused by the parameter change from FIR to PIR, it is recommended that sequence {0,2,4,0,2,4, . . . } be selected , otherwise sequence {0,2,4,6,0,2,4,6, . . . } is recommended.

The limit for retransmissions is typically predetermined in standards or in system specifications.

The use of the embodiment is not restricted to the QPSK or 16-QAM modulation methods, but it can be adapted to other modulation methods as well. There, QPSK and 16-QAM are taken only as examples.

The embodiment ends in block 208.

The embodiment may be repeated for example for a retransmission of the following erroneous packet.

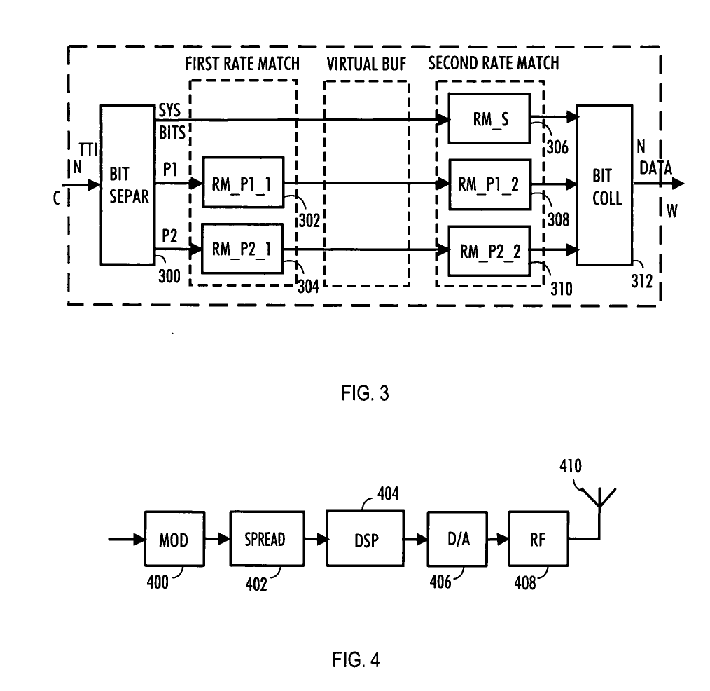

Next, an example of HS-DSCH hybrid (H) ARQ functionality is disclosed in more detail by means of FIG. 3.

H-ARQ is an important feature in making HSDPA suitable for Wide Band Code Division Multiple Access (WCDMA) systems. H-ARQ controls and initiates packet transmission on layer 1 to reduce retransmission delay. The H-ARQ functionality comprises two-rate matching stages (first rate matching and second rate matching) and a virtual buffer, as shown in FIG. 3. The second rate matching stage matches the number of bits after the first rate matching stage to the number of physical channel bits available in a HS-PDSCH set in one TTI.

In block 300, input bits are separated into systematic bits and parity bits. Parity bits are divided into two classes: first parity bits (P1) and second parity bits (P2).

In the first rate matching, in blocks 302 and 304, the parity bits are punctured according to the selected system.

The second rate matching stage, blocks 306, 308 and 310, matches the number of bits after the first rate matching stage to the number of physical channel bits available in the TTI (marked as Ndata). The bits are collected after the rate matching in block 312.

FIG. 4 shows an example of a transmitter, which is typically placed in a network element, such as a base station, or in another communication device, without being restricted thereto. It is obvious for a person skilled in the art that the structure of the transmitter may vary according to the current implementation.

In a transmitter, the signal is first modulated in block 400. Modulation means that a data stream modulates a carrier. The modulated signal characteristic may be frequency or phase, for example. Modulation methods are known in the art and therefore they are not explained here in greater detail.

Because the system in FIG. 4 is a wide-band system, the signal is spread for example by multiplying it with a long pseudo-random code. Spreading is carried out in block 402. If the system is a narrow-band system, the spreading block is not required.

In DSP (Digital Signal Processing) block 404, the signal to be transmitted is usually processed in several ways, for instance it is encrypted and/or coded. The DSP block may also include modulation means of block 400 and spreading means of block 402. The embodiment of the data processing method described above is typically carried out in the DSP block.

Block 406 converts the signal into an analogue form. RF parts in block 408 up-convert the signal to a carrier frequency, in other words a radio frequency, either via an intermediate frequency or straight to the carrier frequency. In this example, RF parts also comprise a power amplifier which amplifiers the signal for a radio path.

The transmitter has an antenna 410. If a receiver and a transmitter use the same antenna, there is a duplex filter (not shown) to separate transmission and reception. The antenna may be an antenna array or a single antenna.

The disclosed functionalities of the described embodiments of the coding method can be advantageously implemented by means of software (a computer program) which is typically located in a Digital Signal Processor. The implementation solution can also be, for instance, an ASIC (Application Specific Integrated Circuit) component. A hybrid of these different implementations is also feasible.

Even though the invention is described above with reference to an example according to the accompanying drawings, it is clear that the invention is not restricted thereto but it can be modified in several ways within the scope of the appended claims.

1. A data processing method in a communication system, the method comprising:
searching for and storing a maximum limit for a combined coding rate;
selecting a first coding rate for a first transmission;
selecting a new coding rate for a following transmission based on the maximum limit of the combined coding rate and the first coding rate if a retransmission is required.

2. The method of claim 1, wherein the new coding rate selection is based on redundancy version (RV) parameter selection.

3. The method of claim 1, wherein the new coding rate selection is based on examining performance degradation in a turbo decoder caused by coding rate combinations, taking into consideration a performance loss caused by a decreased number of previously punctured parity bits to be transmitted.

4. The method of claim 1, wherein the new coding rate selection is based on redundancy version (RV) parameter selection and RV parameter sequences for following retransmissions depend on an RV parameter used in a previous transmission.

5. The method of claim 1, wherein the new coding rate selection is based on redundancy version (RV) parameter selection, and an optimal RV parameter is maximized in the retransmission, wherein a number of parity bits that were punctured in previous transmissions maximize a coding gain without causing performance degradation in a turbo decoder.

6. The method of claim 1, further comprising evaluating whether the combined coding rate leads to performance degradation of a turbo decoder by calculating:
$$\vert {CR}_{2} - \frac{3.5 N}{3.5 N + 2} \vert < ɛ ,$$
wherein
CR₂ denotes the combined coding rate,
ε is the maximum limit for the combined coding rate,
$$N = \vert \frac{4 I}{7 \cdot min ( P 1 + P 2 , 2 \cdot {N}_{data} - I )} + 0.5 \vert ,$$
wherein
I denotes a number of systematic bits in an output of a turbo encoder,
min denotes a minimum,
P1 denotes a number of first parity bits in the output of the turbo encoder,
P2 denotes a number of second parity bits in the output of the turbo encoder, and
N_{data}=480·S·N_{codes},
wherein
S=2 for quadrature phase shift keying (QPSK),
S=4 for 16-quadrature amplitude modulation, and
N_{codes} denotes a number of high speed downlink shared channel codes.

7. A transmitter, comprising:
searching means for searching for and storing a maximum limit for a combined coding rate;
selecting means for selecting a first coding rate for a first transmission;
selecting means for selecting a new coding rate for a following transmission based on the maximum limit of the combined coding rate and the first coding rate if a retransmission is required.

8. The transmitter of claim 7, wherein said selecting means for selecting a new coding rate comprises means for selecting the coding rate based on Redundancy Version (RV) parameter selection.

9. The transmitter of claim 7, wherein said selecting means for selecting a new coding rate comprises means for selecting the coding rate based on examining performance degradation in a turbo decoder caused by coding rate combinations, taking into consideration a performance loss caused by a decreased number of previously punctured parity bits to be transmitted.

10. The transmitter of claim 7, wherein said selecting means for selecting a new coding rate comprises means for selecting the coding rate based on redundancy version (RV) parameter selection, and wherein RV parameter sequences for following retransmissions depend on an RV parameter used in a previous transmission.

11. The transmitter of claim 7, wherein said selecting means for selecting a new coding rate comprises means for selecting the coding rate based on redundancy version (RV) parameter selection, and an optimal RV parameter maximizes, in the retransmission, a number of parity bits that were punctured in previous transmissions to maximize a coding gain without causing performance degradation in a turbo decoder.

12. The transmitter of claim 7, further comprising evaluating means for evaluating whether the combined coding rate leads to performance degradation of a turbo decoder by calculating:
$$\vert {CR}_{2} - \frac{3.5 N}{3.5 N + 2} \vert < ɛ ,$$
wherein
CR₂ denotes the combined coding rate,
ε is the maximum limit for the combined coding rate, and
$$N = \vert \frac{4 I}{7 \cdot min ( P 1 + P 2 , 2 \cdot {N}_{data} - I )} + 0.5 \vert ,$$
wherein
I denotes a number of systematic bits in an output of a turbo encoder,
min denotes a minimum,
P1 denotes a number of first parity bits in the output of the turbo encoder,
P2 denotes a number of second parity bits in the output of the turbo encoder,

|x| denotes absolute value of x, and
N_{data}=480·S·N_{codes},
wherein
S=2 for quadrature phase shift keying (QPSK),
S=4 for 16 quadrature amplitude modulation, and
N_{codes} denotes a number of high speed downlink shared channel codes.

13. A component of a transmitter, the component comprising:
searching means for searching for and storing a maximum limit for a combined coding rate;
selecting means for selecting a first coding rate for a first transmission;
selecting means for selecting a new coding rate for a following transmission based on the maximum limit of the combined coding rate and the first coding rate if a retransmission is required.

14. A network element, comprising:
searching means for searching for and storing a maximum limit for a combined coding rate;
selecting means for selecting a first coding rate for a first transmission;
selecting means for selecting a new coding rate for a following transmission based on the maximum limit of the combined coding rate and the first coding rate if a retransmission is required.

15. A computer program embodied on a computer-readable medium, the computer program to control a computer process for data processing to perform the steps of:
searching for and storing a maximum limit for a combined coding rate;
selecting a first coding rate for a first transmission;
selecting a new coding rate for a following transmission based on the maximum limit of the combined coding rate and the first coding rate if a retransmission is required.

16. A transmitter, configured to:
search for and store a maximum limit for a combined coding rate;
select a first coding rate for a first transmission;
select a new coding rate for a following transmission based on the maximum limit of the combined coding rate and the first coding rate if a retransmission is required.

17. A component of a transmitter, the component configured to:
search for and store a maximum limit for a combined coding rate;
select a first coding rate for a first transmission;
select a new coding rate for a following transmission based on the maximum limit of the combined coding rate and the first coding rate if a retransmission is required.

18. A network element, configured to:
search for and store a maximum limit for a combined coding rate;
select a first coding rate for a first transmission;
select a new coding rate for a following transmission based on the maximum limit of the combined coding rate and the first coding rate if a retransmission is required.

19. A computer program product encoding a computer program of instructions for executing a computer process for data processing, the computer process configured to:
search for and store a maximum limit for a combined coding rate;
select a first coding rate for a first transmission;
select a new coding rate for a following transmission based on the maximum limit of the combined coding rate and the first coding rate if a retransmission is required.
